(19) United States
(12) Patent Application Publication
(10) Pub. No.: US 2005/0182663 A1
(43) Pub. Date: Aug. 18, 2005

(54) Method of examining a plurality of sites for a clinical trial

(76) Inventors: Klaus Abraham-Fuchs, Erlangen (DE); Gudrun Zahlmann, Neumarkt (DE); Rainer Kuth, Herzogenaurach (DE); Eva Rumpel, Erlangen (DE); Siegfried Schneider, Erlangen (DE); Markus Schmidt, Nuernberg (DE); Horst Schreiner, Fuerth (DE)

Correspondence Address: HARNESS, DICKEY & PIERCE, P.L.C., P.O.BOX 8910, RESTON, VA, 20195, US

(21) Appl. No.: 10/975,009

(22) Filed: Oct. 28, 2004

Related U.S. Application Data
(60) Provisional application No. 60/545,165, filed on Feb. 18, 2004.

(51) Int. Cl. G06F 17/60

(52) U.S. Cl. 705/3

(57) ABSTRACT

A method is proposed for examining a plurality of sites for a clinical trial. The method includes obtaining criteria for clinical trial and determining, using a computer device, how information regarding each of a plurality of clinical trial sites relates to the obtained criteria. Based upon the determinations, a plurality of the clinical trial sites are ranked. Thereafter, the ranked clinical trial sites may be reported to a sponsor of the clinical trial, and payment may be received.

The present application hereby claims priority under 35 U.S.C. §119 on U.S. provisional patent application No. 60/545,165 filed Feb. 18, 2004, the entire contents of which are hereby incorporated herein by reference.

### FIELD OF THE INVENTION

The present invention is generally related to the field of clinical studies.

### BACKGROUND OF THE INVENTION

The framework for traditional business models for clinical studies has been rather stable over the last few decades. In such a business model, a sponsor (such as a pharmaceutical company which has developed a new drug, for example) paid all participants which performed in the study. At a minimum, these included participating patients and a medical doctor (an investigator) in charge of supervising the patients. In many cases, an investigation or clinical trial site (e.g., a hospital) was additionally included, where one or more investigators was employed.

So called contract research organizations (CROs) further established their services in the workflow chain of clinical studies, in between the sponsor on one end, and the investigator and patients on the other. The CRO often took over the complete management of the clinical study, including all necessary services including, for example, development of study protocol, recruiting patients and investigators and/or investigation sites, contracting the participants, supervising the conductance of the study, collecting and evaluating data, channeling the payment from the sponsor to the participants, etc. Of course, for such services, the CRO received a substantial part of the aforementioned payment for their own services.

When recruiting the patients, the CRO, or even the sponsor, tended to use and still uses crude methods wherein prospective patients fill out forms and are screened as candidates for clinical studies. The data utilized is normally that obtained from the patient himself or herself. Regarding the investigator or investigator/clinical trial site chosen to conduct/monitor/etc. the study, information previously obtained by the sponsor or CRO can be used. However, this is often a slow process which often does not produce an ideal patient, investigator or investigator/clinical trial site.

FIG. 1 illustrates a typical traditional cash flow system for use in connection with clinical studies. Initially, a sponsor 100 (such as a drug manufacturer, for example) defines the study requirements or criteria (study parameters, study protocol, etc.) for the particular clinical study in question. A CRO 120 may then be employed to manage the study, noting that the CRO 120 may develop the study requirements or criteria of the clinical study or may assist therein. The CRO may also assist in recruiting patients for the study, as well as selecting an appropriate investigator/investigators and appropriate clinical trial site(s). If a CRO is involved, the CRO is paid by the sponsor 100. The CRO then manages the study and then pays others involved in the study including investigators 130, patients 140, and potentially investigation or clinical trial sites such as hospitals, for example (not shown).

This traditional cash flow model had some flaws. For example, it did not foresee making payments dependant on the quality of delivered performances. This was mainly because it was very difficult to impossible in the past to measure the quality of performance. Therefore it was neither possible for the sponsor to save money by paying less for a performance which was more inferior than expected; nor was it possible to reward excellent performance through additional incentives.

Further, there are additional problems of recruiting patients who are not ideal for a clinical study; choosing non-ideal investigator sites; etc. Further, when an investigator/hospital is chosen, it is very difficult to change, and even becomes more difficult the closer one gets to beginning the clinical trial.

Currently, pharmaceutical companies know a number of investigator sites/hospitals very well. However, such knowledge does not cover every country nor every field of disease. The majority of CROs have a very regional focus.

While participating in a clinical trial, investigator sites (clinical test sites) were reimbursed (or receive incentives) according to the number of patients they enroll into and maintain in the clinical study. Therefore, in the past, some sites were tempted to enroll non-eligible patients or to reduce the compliance with the test protocol if a dropout of patients would be the alternative. However, non-eligible patients were detected at the final data analysis and then had to be eliminated from the data set at a very late phase. Thus, money was wasted and a risk to the clinical trial was created as the minimum number of patients required may not have been achieved in time.

Although a moderate volatility in trial compliance may not have been detected by standard means, the scattering of results generated by a not-standardized assessment of data reduced the significance of the results of the clinical trial and may even have caused a failure of the trial attempt. When starting a trial at each site, staff had to be trained, materials had to be delivered, resources provided. Each site failing to enroll the projected number of patients caused a major delay and decreased the (economic) efficiency of the trial.

All of these examples demonstrate that a well-selected investigator site is an essential step towards a successful trial. Any means to support site selection and compliance will be of great value for a trial sponsor. Employees of trial-related companies (e.g. the salespersons of a pharmaceutical manufacturer, a clinical research associate of a contract research organization (CRO)) know by their professional experience and personal relations about the reliability of an investigator site. However, their assessment may be biased. The lack of objective, measurable criteria is especially felt, if new test sites have to be identified.

### SUMMARY OF THE INVENTION

The present inventors have recognized problems with the traditional clinical study model. They have recognized and discovered a need for a more national/global focus regarding investigator sites/hospitals and a need to choose the right investigator sites/hospitals for the right studies. Thus, they have recognized and discovered a need to provide objective criteria to use for ranking or grading investigator sites/hospitals. As a result, reimbursement/incentive can then be tied to rankings and thus quality factors can be used in selecting investigator sites/hospitals for a clinical study.

An object of one embodiment of the present application is to improve on the traditional clinical study model, and thus improve the clinical study or clinical study process. One specific object involves improving cost-effectiveness of a clinical study. In one embodiment, this can include, for example, the use of clinical IT infrastructure to derive, when correlated with obtained criteria of a clinical study, determining a ranking of clinical trial sites (investigators/hospitals). Thus, using a computer device, it may be determined how information regarding each of a plurality of clinical trial sites relates to the obtained criteria, such that a plurality of the clinical trial sites may be ranked based on the determinations. As such, the sponsor may then better determine appropriate payment to a clinical trial site based on projected patient and clinical trial site quality. For example, a benchmark threshold of acceptability can be established and the sponsor can then chose among the ranked clinical trial sites (using a trade-off between quality and price).

Further, the inventors have recognized that in the traditional setting of a clinical study, the CROs had no access to this IT infrastructure. The investigation or clinical trial sites such as a hospital, for example, were the owner of such IT infrastructure and databases. As such, the sponsors and CROs had no such access. However, as these investigation/clinical trial sites were biased parties and thus sponsors of clinical studies and CROs were not interested in their involvement to the extent of using their IT infrastructure.

The present inventors, in one embodiment of the present invention, have recognized that further value of such clinical IT databases can be obtained when clinical data from a plurality of different investigation sites is used, especially different investigation sites participating in the same clinical study. This added value can be provided by an independent party, a solution provider who can develop, sell, install and maintain clinical IT solutions and databases, and in many cases can also store and maintain related databases obtained from a correlation of the traditional clinical IT databases and clinical study criteria.

The present inventors, in one embodiment of the present invention, also recognized the importance of the introduction of some type of quality control and benchmarking measures. By inclusion of various measures, the payment for the clinical study can be made to be performance/outcome oriented, rather than oriented as contracts for upfront fixed amounts.

An embodiment of the present application is directed to a method of improving a clinical study. The method may include obtaining criteria for the clinical study; comparing the clinical data with the obtained criteria using a computer device; and deriving, using the computer device, performance measures for improving the clinical study. These performance measures may be used for ranking, and consequently improving, the clinical study. Further, the criteria for the clinical study may include at least one performance parameter, wherein performance parameter measures are derived for at least one performance parameter.

In another embodiment, a method of improving a clinical study may include creating first electronic database of criteria for the clinical study and creating a second electronic database with rules for calculating performance measures from the criteria and from clinical data. The first and second databases and the clinical data may then be evaluated to calculate performance measures. The performance measures may then be stored in a third database and, from the third database, a ranking of the performance measures may be derived for use in improving the clinical study. Further, the criteria for the clinical study may include at least one performance parameter, wherein performance parameter measures are calculated for at least one performance parameter.

In another embodiment of the present application, a method for providing sites for a clinical trial may include determining, using a computer device, a relationship between information regarding each of a plurality of clinical trial sites relates and criteria for a desired clinical trial. Further, the method may then include providing a level of guarantee of performance for at least one of the plurality of the clinical trial sites, for the desired clinical trial, based on the determinations.

In another embodiment of the present application, a methodology has further been developed for examining a plurality of sites involved in clinical trial studies. Such a methodology includes obtaining criteria for clinical trial; determining, using a computer device, how each of a plurality of clinical trial sites is performing a clinical trial study, based upon the obtained criteria; and ranking the performance of the plurality of the clinical trial sites based on the determinations.

Other embodiments of the present application may include devices for implementing any of the aforementioned methods, programs adapted to perform any of the aforementioned methods when executed on a computer device, and/or computer readable mediums storing any of the aforementioned programs.

Additional embodiments of the present application may include apparatuses for ranking a plurality of clinical trial sites for potential performance of a clinical trial. One such apparatus, in one embodiment, may include a first electronic database including criteria for the clinical study; a second electronic database including rules for calculating performance measures from the criteria and from clinical data; a rules engine, adapted to interface with and evaluate the first and second databases and the clinical data to calculate the performance measures. Finally, a third database may then be included for storing the calculated performance measures. A ranking of the performance measures may then be derivable from the third database for use in improving the clinical study.

For a full understanding of the nature and advantages of the various aspects of the invention, reference should be made to the detailed description of exemplary embodiments taken in conjunction with the accompany drawings. The detailed description provides only exemplary embodiments of the invention and thus, the claims of the present invention should not be limited as such.

### BRIEF DESCRIPTION OF THE DRAWINGS

The present invention will become more fully understood from the detailed description of preferred exemplary embodiments given hereinbelow and the accompanying drawings, which are given by way of illustration only and are thus not limitive of the present invention, and wherein:

FIG. 1 illustrates a typical traditional cashflow business model for use in clinical studies;

FIG. 2 is an example of a first embodiment of the present application illustrating the use of a solution provider;

FIG. 3 illustrates an exemplary embodiment of the present application.

### DETAILED DESCRIPTION OF THE EXEMPLARY EMBODIMENTS OF THE PRESENT APPLICATION

It is proposed that a clinical research service provider, in extension to the services offered by the CRO's of today, provide (for a fee for example) a ranked list of investigator (clinical trial) sites to the sponsors of clinical studies, who are in search of suitable sites. The ranking of the sites may be based on objectively measurable criteria. One added value delivered by the service provider, in at least one embodiment for example, is to apply such objectively measurable criteria to patient databases from potential investigator sites (and optionally to use result protocols from previous clinical studies done by the investigator sites). The service provider has access to such databases from a multitude if investigator sites, may evaluate all such databases in a standardized, and such comparable, way, and may deliver a ranked list of potential sites to the sponsor.

One aspect of one embodiment of the present application is to improve on the traditional clinical study model, and thus improve the clinical study or clinical study process. One specific object involves improving cost-effectiveness of a clinical study.

In one embodiment, this can include, for example, the use of clinical IT infrastructure to derive, when correlated with obtained criteria of a clinical study, to determine a ranking of clinical trial sites (investigators/hospitals). Thus, using a computer device, it may be determined how information regarding each of a plurality of clinical trial sites relates to the obtained criteria, such that a plurality of the clinical trial sites may be ranked based on the determinations. As such, the sponsor may then better determine appropriate payment to a clinical trial site based on projected patient and clinical trial site quality. For example, a benchmark threshold of acceptability can be established and the sponsor can then chose among the ranked clinical trial sites (using a trade-off between quality and price, for example).

Criteria for a clinical study may be obtained for example, from a clinical study protocol, target performance parameters of the clinical study. One example of two types of quantitative criteria which can be applied to quantify the reliability of a test site:
1) parameters determining the site eligibility status in advance of a clinical trial, which can include, but are not limited to:
   sponsor-independent trial experience
   patient profiles evaluated directly from the patient database or equivalent
2) parameters determining the performance status of a clinical trial site during the ongoing study (e.g. algorithms and procedures to assess and quantify the validity of data collected during a trial, which have been described by the authors reporting, for example, “Qualitätsorientierte Bewertung klinischer Studiendaten” [DE 10 2004 008 197.2], the entire contents of which is hereby incorporated herein by reference.

Further, the information regarding a plurality of clinical trial sites may include for example, but is not limited to a number of patients at a site; an indication of clinical trial experience; information concerning the obtained criteria for the clinical trial; quality and quantity parameters; etc.

In addition, the criteria obtained may include weighting factors, wherein the ranking is based upon weighted determinations. The weighting factors may include for example, but are not limited to at least one of time for performing a clinical trial, quality, and geographic location.

The first set of parameters may be used to create a ranked list of investigator sites. This list may be generic, taking into account the previous experience of the clinical trial site, staff training status in general or institutional size and resources. However, such a ranked list can be preferably customized specifically for an intended trial, taking into account for example, the prevalence of the sought patient type at the respective site, the domain-specific experience and training of the clinical staff and other personnel, technical resources, etc.

A benchmark or threshold of acceptability may further be used to separate the eligible and the non-eligible sites. Such a ranked list will allow the sponsors to identify sites with a potential to deliver high-quality results. For the provision of such a ranked list, the sponsor may then be charged for the service by the service provider, for example in dependence of its trial-specificity, its number of institutions beyond industry benchmark, the patient numbers these institutions represent, other parameters, etc.

Thus, in one embodiment, the method may be for ranking sites for a clinical trial, and may include obtaining criteria for clinical trial and determining, using a computer device, how information regarding each of a plurality of clinical trial sites relates to the obtained criteria. From there, it may be determined, from the determined information, which of the plurality of sites further meet a threshold of acceptability. Thereafter, the sites which meet the threshold of acceptability may be ranked.

Further, monitoring of the at least one site during at least one clinical trial can occur, along with re-ranking of the plurality of sites based upon the monitored information. Still further, the ranked clinical trial sites may be grouped into categories of at least two groups for example (such as high quality, average quality and low quality sites based on thresholds, for example). In addition, the ranked clinical trial sites may be reported to a sponsor of the clinical trial, and at least one group may be eliminated prior to reporting the ranking. Thereafter, the service provider may receive compensation for the reported ranking.

The second set of parameters may be used to classify the results the respective investigator site delivered during the trial. The incentives of the clinical trial sites may depend on their compliance with the agreed performance level. The service provider may then charge the sponsor for providing the methods and metrics to perform a quality based compensation of the investigator sites.

In order to calculate a ranking score from multiple quantitative parameters, which have been derived from the databases, a formula may be provided to or derived by the service provider. In contrast to generally valid ranking lists, the service provider can evaluate the potential investigators (clinical trial sites) with specific emphasis on aspects which are relevant for the new clinical study. This may be done by way of an appropriately developed ranking score formula. In the simplest case, this may be an arithmetic average, or the sum of the scores of all single parameters. In a more sophisticated case, this formula may use weighting factors etc. to tailor the ranking score to the specific needs of a sponsor and the new study. Optionally, the service provider may present an (electronic) questionnaire or checklist to the sponsor, to determine specific needs for particular clinical study, and may directly derive “tailoring” weighting variables contained in the formula from these questionnaires.

As an example, these variables in the formula may be weighted factors for each of the objectively measurable criteria of the clinical study, which may be chosen according to their relevance to the new clinical study. For example, if the clinical study requires diabetic patients, then the incidence of diabetic patients in the clinical trial site may be weighted with 100%, whereas the weight factor or other, not relevant patient groups, may be set to 0%.

Ranking/weighting criteria may include for example, but are not limited to:
does the clinical site provide the required diagnostic tools and measurement devices or have the patient to be referred to a third party institution;
does the site provide staff specifically trained and/or certified for clinical studies;
is staff full-time available for clinical studies or to what extent;
how many eligible patients (according data base query for example) does the study site provide;
what drop out rate did the site show in earlier studies;
how many queries per patient had been returned to the site in earlier studies;
what has been the response time of the site in earlier studies;
etc.

A non-limiting example for an algorithm, ranking different study sites could be:
points=N*[w1(1−DR)+w2*SPR+w3(1−QPR)]
N: number of patients eligible according data base query;
w1: weighting factor of drop out rates in earlier studies;
DR: average drop-out rate in earlier studies;
w2: weighting factor for staff qualification and availability;
SPR: staff patient ratio (certified staff only);
w3: weighting factor for documentation quality on earlier studies; and
QPR: number of queries per patient necessary due to spoiled/unreadable data in earlier studies.
   The higher the points, the higher the quality of the respective study site.

The information obtained relating to a clinical trial site, to be compared with the clinical study criteria may include, but is not limited to, information on the sites technical infrastructure; information on the sites personnel resources; information on the sites prior study experience; information on the sites prior study performance; information on the sites patient profile; information on the sites current patients; etc. This information may be obtained from existing IT infrastructure/databases as will be explained hereafter and/or from other sources including but not limited to questionnaires to the study site; audits of the study site; data base queries; etc.

In another embodiment, the method may be for providing sites for a clinical trial, and may include determining, using a computer device, a relationship between information regarding each of a plurality of clinical trial sites relates and criteria for a desired clinical trial. Thereafter, a level of guarantee of performance may be provided for at least one of the plurality of the clinical trial sites, for the desired clinical trial, based on the determinations. Further, a plurality of varying levels of guarantee may be provided for a plurality of the clinical trial sites.

Clinical data can include data stored in a database of existing clinical IT infrastructure, such as an electronic healthcare database, for example. This can include, but is not limited to at least one of a database with electronic patient records, a database of clinical workflow management system, information from a hospital IT system (financial or clinical), information from a laboratory or radiology information system, information from a picture archiving and communication system (PACS), information from a physician's IT system, for example, etc.

In the past, the clinical trial business models did not make use of clinical IT infrastructure and databases, such as electronic patient records (EPR), hospital information systems (HIS) or clinical workflow management systems. In an embodiment of the present application, such clinical IT infrastructure and databases, storing various types of clinical data, are utilized in connection with obtained criteria for the clinical study, to derive performance measures of the study, which can then be used to improve the study (and/or the clinical study business process). Further, the criteria for the clinical study may include at least one performance parameter, wherein performance parameter measures are derived for at least one performance parameter.

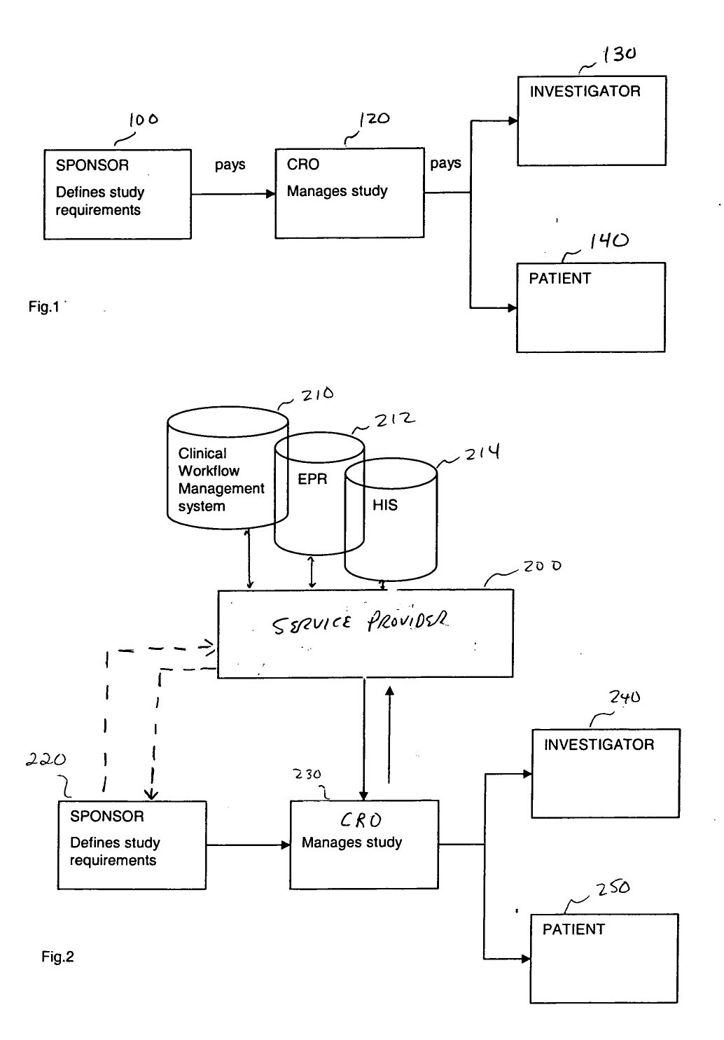

As shown in FIG. 2 of the present application, the role of a service provider 200 is now introduced into the clinical study process and business model. A service provider 200, for example, develops, markets, sells and maintains software to support all types of clinical processes and the necessary IT infrastructure to run this software, i.e. computers, computer interfaces, computer networks, and mass storage devices. The term “service provider” refers to, for example, the fact that such software and infrastructure is not sold off the shelf, without further contact to the customer after the sale. In contrast, both software and IT infrastructure is typically adapted to the customers needs and is typically maintained by the service provider 200 during a continuous service contract.

Often, such Hospital IT solutions include also the service to store and backup the huge amount of clinical data at service provider-owned mass data storage devices. Typically, the solution business also includes building a model of the customers individual clinical processes, describing this model with a computer based workflow language, and uploading this electronic workflow model into the rules engine of the clinical workflow IT.

Due to this highly interactive role of the service provider 200 in this solution provider business model, the service provider 200 often has both physical access to a considerable part of electronic clinical data, a deep understanding of his customer's clinical process, and access to the electronic model and rules engine of the clinical process. As a consequence of the electronic modeling of the clinical workflow, performance data on the workflow can be derived in an automated electronic way, and retrieved from the IT system. Since a clinical study is a special case within the general clinical workflow, it is within the scope and competence of the service provider 200 to make use of the clinical IT infrastructure described above to improve also the clinical study process.

Through his ability to access the Hospital IT (infrastructure and databases), the service provider 200 is able to analyze clinical data, such as that stored in any of the clinical workflow management system 210, EPR 212, HIS 214 (or any other type of clinical IT infrastructure and/or database). This service provider 200 connects or is otherwise networked to, and can thereby access/receive and then analyze data from any of the clinical workflow management system 210, EPR 212, HIS 214 (or any other type of clinical IT infrastructure and/or database). The service provider 200 may further be networked or otherwise connected to the sponsor 220 and/or the CRO 230. The service provider 200 then receives or otherwise obtains criteria for a clinical study from the sponsor 220 and/or CRO 230 and can then compare the obtained clinical data to (analyze in conjunction with or based upon) the obtained criteria for a clinical study. The service provider 200 of an embodiment of the present application is then able to derive performance measures and other elements for ranking the clinical trial sites in relation to the clinical study or studies for which the criteria was obtained. Further, the criteria for the clinical study may include at least one performance parameter, wherein performance parameter measures are derived for at least one performance parameter.

As shown in FIG. 2, the service provider 200 can receive requirements of the clinical study directly from the sponsor 220, which can include the criteria for the clinical study; and/or can receive such information from the CRO 230 managing the study; noting that the CRO 230 may take on all necessary services for managing the study including, but not limited to development of a study protocol, recruiting patients and investigators and/or investigation or trial sites, contracting the participants, supervising the conductance of the study, collecting and evaluating the data and channeling the data from the sponsor to the participants. Thus, the CRO 230 and/or sponsor 200 may transmit information regarding desired/necessary criteria of the clinical study (and even desired target parameters) to the service provider 200. The CRO 230 and/or sponsor 200 and/or may further be involved in funneling payment to the service provider 200.

The payment to the service provider 200 may be for achieving advantages such as reduced time or cost savings or other performance parameter aspects, wherein the service provider 200 may be involved in calculating potential advantages obtained from using certain clinical trial sites/patients/investigators/etc. determined to exceed target performance parameter measures or other aspects of the obtained criteria. Clinical data of a plurality of clinical trial or investigation sites/patients/investigators/etc., and the obtained criteria, may be further analyzed or compared to rank clinical trial or investigation sites, and/or to determine clinical trial or investigation sites which meet or exceed target performance parameter measures of the obtained criteria. This ranked information can then be output or otherwise sent to the sponsor 220 and/or CRO 230 for use in determining desired patients/clinical trial sites/investigators/etc. for use in the study and the service provider 200 can then be paid or contracted for some portion of savings projected and/or achieved. Finally, the CRO 230 may be involved in paying a portion of the money to the investigators 240, the patients 250 and/or to the investigation sites not shown. Alternatively, if the CRO 230 is not involved, the service provider 200 may be involved in making such payments.

Throughout various embodiments of the present application, reference is made to “performance parameters”. With regard to such performance parameters, these can include but are not limited to study duration, costs, study result reliability, and any other “measurable” form of value to a sponsor 220 regarding the clinical study (thus resulting in performance parameter measures, namely some “measure” of a performance parameter).

Such performance parameters are very important to a clinical study and can thus result in a huge savings to the sponsor, a portion of which can thus be passed on to the service provider 200. For example, the faster the clinical study can be performed (the shorter the duration), the sooner a product (such as a drug, for example) can go to market. Each day on the market can lead to thousands and even millions of dollars. Further, if costs of the clinical study can be reduced, savings are achieved. Regarding study reliability, the more reliability can be improved, the more valuable the clinical study is and the potentially faster the drug, for example, can go to market. In addition, if poor study reliability can be detected early in a clinical trial, the study at a particular trial site for example, can be terminated quickly, again resulting in an overall savings to the sponsor 220. Such performance parameter measures can be derived and/or calculated based upon clinical study criteria which may include target performance parameter measures.

Other non-limiting examples of “performance parameters” can include, but are not limited to:
Number of patients with a given diagnosis of “criteria” having been treated by the clinical study site previously;
Number of patients with a given diagnosis of “criteria” having been enrolled in the clinical studies by the clinical study site;
Number of missing clinical examination data from the “accompanying examination criteria” from patients previously enrolled in other clinical studies (corresponding to compliance of the clinical site to do all required exams); etc.

“Criteria”, as referenced throughout the embodiments of the application, refers to clinical study criteria. These “criteria” are important aspects of the clinical study. These criteria of the study can be used by the service provider 200 to formulate desired performance parameters and then, using existing clinical data, projected performance parameter measures can be calculated for one or more patients/investigators/clinical trial sites/etc. Thus, the criteria outline key or other important aspects of the study which, when provided and correlated with clinical data, can help produce likely performance parameter measures that have an effect or importance regarding an outcome of the study (effect on time to perform the study, cost of the study, etc.).

Some non-limiting examples of “criteria”, which may influence or help to determine performance parameters/performance parameter measures or other clinical study measures positively may include, but are not limited to:
Number of patients needed for the clinical study;
Patient inclusion criteria such as, for example, patients with a given diagnosis (e.g., diabetes type I, for example). Another example of patient inclusion criteria can be, for example, age group (e.g., 40-60 years) of patients to be included in the study;
Patient exclusion criteria: Patients not previously diagnosed with an ailment, (hypertension, for example). Another example of patient exclusion criteria can be, for example, patients not having been prescribed with a given medication “x” previously;
Accompanying exams to be undertaken during the study (aside from prescribing the medication under study) to the patient: This can include, but is not limited to regular (i.e., weekly, daily, etc.) control of blood pressure, heart rate, etc.; Making diagnostic images for the therapy success control every “x” days/months/years; etc.

Often, elements relating to this “criteria” cannot be measured directly, but must be deduced from other measurable parameters or clinical data, and perhaps from a combination of other measurable parameters or other measurable clinical data. Thus, the service provider 200 can, for example, build an empirical database for use in such situations. As one example, such a database can be built based on, for example, typical “dropout” rates of patients (i.e. percentage of patients who discontinue participation in the study before the scheduled termination of the study), wherein these rates might vary with investigation sites, patient age, geography, etc. Thus, the service provider 200 can create a type of mathematical formula or weighting factors regarding the combining of several direct and indirect aspects of the criteria into a prediction of probable benefit, such as probable financial benefit. Most likely, this formula will include a weighted sum or weighted product of several single criteria. This can then be correlated with existing clinical data from the clinical IT infrastructure to derive performance measures or performance parameter measures if the criteria includes performance parameters. Thereafter, an output ranking may be derived from the calculated/derived performance measures, the ranking being based upon weighted determinations using the weighing factors. The ranking can be for any or all of the parameters, and can be for any of single or multiple patients/clinical trial sites/investigators/etc.

As a result, information is available as to which clinical trial site, investigator or patient group performed best in an actual and/or recent clinical study. Performance may be measured as overall performance, averaging across a combination of several criteria for example; as a performance with respect to a specific criterion, etc.

It should be further noted that a level of guarantee of performance for at least one of a plurality of clinical trial sites, for a clinical trial for example, may be provided based on calculated performance measures. A plurality of varying levels of guarantee may be provided for a plurality of clinical trial sites. These levels of guarantees may be based, for example, upon weighted determinations, wherein weighting factors may include one of time for performing a clinical trial, quality, geographic location, etc., factors important to the sponsor 220/CRO 230 in obtaining fast and accurate results for the study.

The assignee of the present application has further been involved in various other inventions regarding clinical studies, and in some cases the use of clinical IT infrastructure, in order to improve the development of clinical study business models and/or the development of clinical study protocols; improving the effectiveness of patient recruiting; controlling the compliance of clinical study protocol rules; etc. The entire contents of each of the following applications is hereby incorporated by reference in the present application:
“Procedure to Identify Eligible Study Patients in an All-Day Setting” (U.S. provisional application Ser. No. 60/545,169, filed Feb. 18, 2004) and corresponding U.S. non-provisional application entitled “A Method Of Recruiting Patients For A Clinical Study”, assigned U.S. application Ser. No. ______, and filed on Oct. 28, 2004;
“Incentive-System for Clinical Trials” (U.S. provisional application Ser. No. 60/545,170, filed Feb. 18, 2004), and corresponding U.S. non-provisional application entitled “A Method Of Monitoring Patient Participation In A Clinical Study”, assigned U.S. application Ser. No. ______, and filed on Oct. 28, 2004;
“Procedure Providing a Benchmarking of Clinical Test Sites and a Concomitant Method of Quality-Based Monetary Compensation”; (U.S. provisional application Ser. No. 60/545,165, filed Feb. 18, 2004) and corresponding U.S. non-provisional application entitled “A Method Of Examining A Plurality Of Sites for A Clinical Trial”, assigned U.S. application Ser. No. ______, and filed on Oct. 28, 2004;
“Risk-Sharing Business Model for the Use of HIS Data to Improve Cost Effectiveness of Clinical Studies” (U.S. provisional application Ser. No. 60/545,168, filed Feb. 18, 2004) and corresponding U.S. non-provisional application entitled “A Method Of Improving A Clinical Study”, assigned U.S. application Ser. No. ______, and filed on Oct. 28, 2004;
“Quality Compliance Improvement in Clinical Studies using IT-Based Clinical Workflow Systems” (U.S. provisional application Ser. No. 60/545,164, filed Feb. 18, 2004) and corresponding U.S. non-provisional application entitled “Method and System For Measuring Quality of Performance and/or Compliance with Protocol of a Clinical Study”, assigned U.S. application Ser. No. ______, and filed on Oct. 28, 2004;
Verfahren zur Durchführung einer klinischen Studie (DE 10 2004 008 196.4);
Verfahren zur Überprüfung der Durchfuhrbarkeit eines medizinischen Vorhabens mit Aufnahmekriterien für Patienten (DE 10 2004 008 189.1);
Verfahren zur Qualitätskontrolle von je an unterschiedlichen, aber vergleichbaren Patientenkollektiven im Rahmen eines medizinischen Vorhabens erhobenen medizinischen Datensätzen (DE 10 2004 008 197.2);
Verfahren und Einrichtung zur Überprüfung der Einhaltung einer Durchführungsvorschrift für eine an einem Patienten durchgeführte medizinische Maβnahme (DE 10 2004 008 190.5);
Verfahren zur Qualitätsbewertung von elektronisch gespeicherten, insbesondere medizinischen, Wissensdaten (DE 10 2004 008 191.3);
Verfahren zur Auswahl eines möglichen Teilnehmers für ein medizinisches Vorhaben anhand eines Auswahlkriteriums (DE 10 2004 008 192.1);
Verfahren und Informationssystem zur Durchführung einer klinischen Studie an einem Patienten. (DE 10 2004 008 194.8);
Verfahren zur Überprüfung der Einhaltung einer einem medizinischen Arbeitsablauf zugeordneten Durchführungsvorschrift (DE 10 2004 008 195.6); and
Verfahren zur Auswahl eines Teilnehmers für ein medizinisches Vorhaben mit Auswahlkriterien für Patienten (DE 10 2004 008 188.3).

Thus, as such, the service provider 200 acts as an additional service party in the workflow chain and adds value in the chain of a clinical study utilizing clinical IT infrastructure and databases such as EPR 212, HIS 214, clinical workflow management system 210, etc. in an advantageous way. As such, payment and cashflow for a clinical study may be performance and outcome dependent.

In one embodiment of the present invention, further value of such clinical IT databases has been realized, wherein clinical data from a plurality of different investigation sites is used, especially different investigation sites participating in the same clinical study. This information adds to the value that can be provided by service provider 200 in FIG. 2 who can develop, sell, install and maintain clinical IT solutions and databases, and in many cases can also store and maintain related databases obtained from a correlation of the traditional clinical IT databases and clinical study criteria.

Thus, it should be understood that FIG. 2, and each of the figures and embodiments of the present application, represents the service provider 200 with access to the clinical workflow management system 210, an EPR 212 and/or an HIS 214 of one, or of a plurality of clinical trial sites. Thus, the clinical data can include data from a plurality of clinical trial sites, and further can include data from a plurality of previously conducted clinical trials. Clinical data from a plurality of clinical trial sites is thereby preferably further analyzed in conjunction with, or compared to the obtained criteria for a clinical study, to determine clinical trial sites which may provide excellent performance measures/performance parameter measures and/or exceed certain target performance parameter measures of the obtained criteria (such as target performance parameter measures, for examples). When such an analysis, comparison or determination is made, names of clinical trial sites, determined to exceed target performance parameter measures of the obtained clinical study criteria, can then be provided to the sponsor 220 and/or can be ranked accordingly. In addition, such names may be provided based upon or in accordance with a ranking.

Stated another way, the method may include further deriving/producing/outputting, from the derived performance measures/performance parameter measures, a ranking of the performance measures/performance parameter measures. The ranking may be for at least one of clinical trial sites, payment amounts and/or other things, such as study discontinuation decisions, suitability of patients for the clinical study, etc. for example. The names of clinical trial sites, determined from the rankings, can then be output to a sponsor who can then make a decision as to which patients are best suited to a study, which clinical investigation or trial sites are best suited to conduct a particular clinical study, etc.

Thus, from performance measures/performance parameter measures, a ranking of the performance measures/performance parameter measures can be derived. The ranking can include suitability of patients for the clinical study, as mentioned above. The phrase “suitability of patients for this clinical study” can be defined as follows.

The clinical study protocol also may contain a subset of criteria which define suitability of patients. This can include for example, but is not limited to: suitable patients being those which, for example, have been diagnosed for a certain disease at least 2 years and no more than 5 years ago; are between the ages of 40 and 60; patients within a distance not exceeding 20 miles from the clinical trial site. Using suitable weighting factors, from criteria, a “suitability score”, ranging e.g. from 0 . . . 100%, can be calculated. For example, a patient of age 50, living 2 miles from the clinical trial site and having been diagnosed 3 years ago, has a ranking of 100%; whereas a patient living 30 miles away, having been diagnosed 5 years ago, and being of age 60 receives a 30% suitability score ranking.

Such rankings/results provide potential savings to the sponsor 220, which can be calculated/estimated from the derived performance measures, and a portion of this potential savings can then be paid/contracted to the service provider 200. The potential savings can be calculated from using the clinical trial sites determined to exceed target performance parameter measures of the obtained criteria. Thereafter, the service provider 200 can be paid and/or contracted for performance of the clinical study based upon the calculated potential savings. The potential savings can include any type of potential advantages, for example, at least one of reduced time and cost savings.

Thus, the service provider 200 can act, based upon calculated potential advantages or potential savings, including at least one of reduced time and cost savings, for example, as an entity who can be contracted on a risk-sharing basis. The service provider 200 can be contracted for performance of the clinical study based upon the calculated potential savings on a risk-sharing basis, based upon at least one of the potential advantages. As such, payment can be contracted or based upon the calculated potential savings, with the payment being based upon a percentage of the achieved savings. This payment/contacting can be made directly from/with the sponsor 220, or from/with the CRO 230, for example.

As previously stated, the service provider 200 can have direct access to the clinical data from one or a plurality of clinical studies, from one or a plurality of investigation clinical trial sites, including access to information in at least one electronic healthcare databases such as a clinical workflow management system 210; EPR 212; and/or HIS 214. However, indirect access to this data can also be provided through the service provider 200, wherein the service provider 200 can then perform an analysis of the clinical data using the obtained criteria for the clinical study (performing a comparison of data and criteria for example), to derive performance measures/performance parameter measures for improving the clinical study. The information regarding the specifics of the clinical study can come from the sponsor 220 or from the CRO 230.

An advantage that the service provider 200 can offer, is access to clinical data such as patient data, clinical workflow data, etc., much earlier than the CRO 230, who receives only bundled data in the form, typically, of milestone reports. A service provider 200 has access to the relevant clinical data in real time, and can extract and update all information on study-relevant clinical data such as patient data, on a daily basis for example. To this end, the service provider 200 can also incorporate new software modules in a clinical workflow management system 210, new data entries in the EPR database 212, etc., in order to specifically collect information on a clinical study. With the use of such real-time data, a much more effective monitoring of the clinical study partners and the achievement of clinical study milestones is possible.

For services of achieving or calculating some potential savings, the service provider 200 may be reimbursed with a certain percentage from the total budget for a clinical study. The cost for a clinical study essentially depends on many factors, including but not limited to the duration of the study, the number of participating patients, etc. Additionally, the last day that it takes for the study to be performed, namely for the reduced time of the study or for each day saved, a particular drug on which this study is based may be on the market one day earlier. Thus, time saving for performing the clinical study is very important to the sponsor and has a tremendous impact on the turnover of the sponsor.

In a more defined business model, the service provider 200 may choose to offer services on a risk sharing basis in a number of ways, including but not limited to the following:
“The study protocol, the contract of the sponsor 220 with the CRO 230, may contain numbers such as a budget for the study, a target duration of the study, a target number of participating patients, and a target threshold for the desired statistical significance of the study result (clinical outcome, etc.);
“The service provider 200 may analyze these numbers, and calculate from his own experience, what percentage he is able to reduce/improve these numbers.”
“The service provider 200 may calculate a cash equivalent of cost reduction for the study and/or turnover increase through earlier market start for the sponsor 220;
“The service provider 200 may offer its services to the sponsor 220, based on a certain percentage (e.g., 30%) of the cost savings/turnover increase; for whatever amount the study budget is reduced or the turnover increased by an earlier market start; then, as compared to the target values in the study protocol/contract, the service provider 200 receives the negotiated percentage of this savings as a reimbursement for his services.”

In an analogous way, the service provider 200 may contract on a risk-sharing basis for the service to accrue patients for a study. The service provider 200 may use the access to the critical IT infrastructure, including but not limited to the clinical workflow management system 210, the EPR 12, the HIS 214, etc. of one or a plurality of clinical study/investigation sites, to identify potential participants. The service provider 200 may then be reimbursed for the number of patients actually contracted, and/or for reducing the time taken to begin the study, as compared with a target value or other parameters for beginning the study as can be found in the study profile (contract) or other criteria obtained regarding the study. Overall, cost effectiveness of the clinical study can be improved by offering services which derive different types of benchmarking and performance criteria from criteria of the clinical study analyzed in conjunction with clinical IT infrastructure, such as information from hospital IT databases (which may taken from multiple investigation/clinical trial sites). Payments can be made the clinical study participants and to the service provider 200 itself within this criteria. Optionally, the service provider 200 can make its own payments pending on the outcome of the study and the risk-shared model.

In an embodiment of the application, the method of improving the clinical study, includes creating a first electronic database of criteria for the clinical study and creating a second electronic database of rules for calculating performance measures from the criteria and clinical data. Thereafter, the first and second databases and the clinical data is evaluated to calculate the performance measures for various clinical trial sites. The performance measures are then stored in a third database and from the third database, a ranking of the performance measures is derived for ranking the clinical trial sites for potential performance of the clinical study. Further, the criteria for the clinical study may include at least one performance parameter, wherein performance parameter measures are derived for at least one performance parameter.

In one embodiment, a first electronic database is built by the service provider 200. This database is built from criteria for the clinical study (rules, values, thresholds, etc.) either automatically or manually, extracting this information from a clinical study protocol for example. This clinical study protocol can be provided directly from the sponsor 220 or can be provided from the CRO 230 based upon the defined clinical study requirements provided by the sponsor 220.

A second electronic database may then created by the service provider 200 with rules on how to calculate performance measures from the criteria and from clinical data. Again, the clinical data can be obtained from an electronic healthcare database, such as a clinical workflow management system 210, an EPR 212 and/or the HIS 214, etc. The criteria can include various target performance parameter measures, wherein clinical data of a plurality of clinical trial sites and the obtained criteria for the clinical study may be further analyzed to determine clinical trial sites which may exceed target performance parameter measures of the obtained criteria. From various performance parameter measures, a ranking of the performance parameter measures can be derived wherein the ranking may be for at least one of clinical trial sites, payment amounts, study discontinuation decisions (namely, decisions as to whether or not a clinical study should be discontinued), and suitability of patients for the clinical study, etc.

Thereafter, once the first and second databases are created, a rules engine can be developed or built, which interfaces to the first and second electronic databases and to the clinical databases such as the workflow management system 210, the EPR 212 and the HIS 214, etc. This rules engine can act in evaluating the first and second databases to calculate the performance measures. The performance measures can be stored in a third database and/or output or imported. Further, the criteria for the clinical study may include at least one performance parameter, wherein performance parameter measures are derived for at least one performance parameter.

Finally, from this third database, a ranking of the performance measures can be derived, or the third database can be evaluated, for use in improving the clinical study. For example, the third database (or the performance measures themselves, not stored in a formal database) can be evaluated to derive a ranking of clinical trial sites, payment amounts, study discontinuation decisions, suitability of patients for the clinical study, etc.

Thus, an apparatus for improving a clinical study can include a first electronic database including criteria for the clinical study and a second electronic database including rules for calculating performance measures from the criteria and from the clinical data. The apparatus can include a rules engine, adapted to interface and evaluate the first and second databases and the clinical data to calculate the performance measures. Finally, a third database can be included for storing the performance measures, wherein a ranking of the performance measures is derivable from the third database for use in improving the clinical study.

Again, in this embodiment, the criteria of the clinical study can be included in the clinical study protocol. The clinical data may be obtained from at least one electronic healthcare database including at least one of those previously set forth. The criteria can include at least one of rules, values and thresholds. Further, the criteria for the clinical study may include at least one performance parameter, wherein performance parameter measures are derived/calculated for at least one performance parameter. In addition, the rules engine may be further adapted to interface with at least one electronic healthcare database including the clinical data, to evaluate the databases and calculate the performance measures/performance parameter measures. Additionally, the ranking may be used for at least one of ranking clinical trial sites, ranking payment amounts, ranking to make study discontinuation decisions, suitability of patients for the clinical study, etc.

The service provider 200 may further suggest or recommend discontinuation of the clinical study if one or more of the target performance parameter measures, rules, values and/or threshold criteria is not met. This discontinuation of a clinical study at a particular clinical trial site, for example, may result in a large reduction in losses or costs which may have been incurred if the study had been continued and unfavorable results were achieved. Thus, this can be a large cost savings to the sponsor 220 and thus the service provider 200 may receive a contracted percentage of money not spent on a probably unsuccessful study, as shown in element 450.

Each of the various embodiments discussed above can include the use of weighting factors. For example, the clinical study criteria obtained can include weighing factors, wherein the weighting factors may reflect a likelihood of the “criteria” to correlate with direct benefit, such as financial benefit, for example. The deriving of the performance measures may e based upon one or more weighting factors. With regard to performance parameters such as study duration, costs, study result reliability, major “criteria” which may help to influence these measures positively may include, but are not limited to:
Overall number of patients which can be enrolled in the study, respectively number of patients per time unit which can be enrolled;
Time-effectiveness of data collection and evaluation;
Compliance of investigator and patient with the study rules;
Experience/capability of the investigator to motivate patients for continued participation until the end of the study, and not drop out earlier;
Claimed amount of compensation from investigator and patient, etc.

Often, these “criteria” cannot be measured directly, but must be deduced from other measurable parameters, and perhaps from a combination of other measurable parameters. Thus, the service provider 200 may, for example, build an empirical database on typical “dropout” rates of patients, wherein these rates might vary with investigation sites, patient's age, geography, etc. Thus, the service provider 200 can create a type of mathematical formula or weighting factors regarding the combining of several direct and indirect criteria into a prediction of probable benefit, such as probable financial benefit. Most likely, this formula will include a weighted sum or weighted product of the single criteria. Accordingly, an output ranking may be derived from the calculated performance parameter and a ranking may be based upon weighted determinations using the weighing factors.

Thus, from performance parameter measures, a ranking of the performance parameter measures can be derived. The ranking may be for at least one of clinical trial sites, payment amounts, study discontinuation decisions and suitability of patients for the clinical study.

It should be further noted that a level of guarantee of performance for at least one of a plurality of clinical trial sites, and/or for other clinical trials, may be provided based on calculated performance measures/performance parameter measures. A plurality of varying levels of guarantee may be provided for a plurality of clinical trial sites. This level of guarantee may be based upon weighted determinations, wherein weighting factors may include one of time for performing a clinical trial, quality and geographic location, etc.

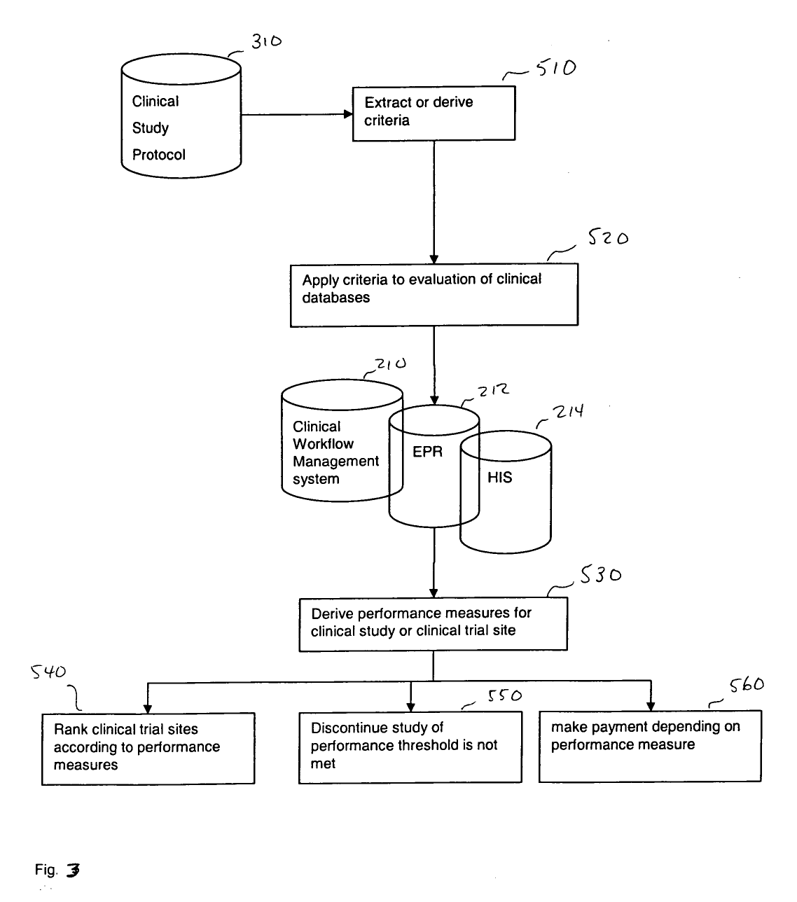

FIG. 3 illustrates an embodiment of a methodology of service provider 200 evaluation of performance parameters. Initially, the clinical study protocol criteria of the clinical study 310 are extracted, derived or obtained as shown in element 510 to FIG. 3. Thereafter, the criteria of the clinical study are applied or correlated, in some manner, to the evaluation of clinical data of clinical databases in step 520. These clinical databases, including clinical data, can include but are not limited to, clinical workflow management system 210, EPR 212, HIS 214, etc. Based upon some type of application/correlation of the criteria for the clinical study to the clinical data in the clinical databases, performance measures for the clinical study (including but not limited parameters for one or more clinical trial sites) are derived as shown in element 530. These performance measures can include measures of study duration and cost, study result reliability, etc., and can then be used to rank various clinical trial sites (for example) according to these performance measures as shown in step 540. The ranking of the clinical trial sites can indicate which clinical trial site(s) is best suited to perform a particular clinical study, for example, and these rankings can be output or provided to a sponsor 220, for example. Further, the criteria for the clinical study may include at least one performance parameter, wherein performance parameter measures are derived for at least one performance parameter.

Further, the performance parameter measures or performance measures can be used in the determination of whether or not the particular clinical study should be discontinued. For example, the derived performance parameter measures or performance measures can be compared to certain required thresholds (or target performance parameters obtained from the clinical study criteria), and a decision can be made in step 550 to discontinue a study if the performance threshold is not met.

The services of the service provider 200 may be contracted to obtain and manage a particular study, to derive the aforementioned ranking of clinical trial sites according to performance parameter measures or performance measures, to receive a contracted percentage of money not spent on a probable unsuccessful study, etc. Further, derived performance parameter measures or performance measures can be used to make payment, by a sponsor to a particular clinical trial site, patient, investigator, etc., based upon a performance parameter measure or parameter achieved as shown in element 560. The service provider 200 may then receive a percentage of money for deriving these particular performance parameter measures or performance measures.

As one non-limiting example of the methodology of one embodiment of the present application, a ranking of the clinical trial sites may be done before a clinical study begins, as follows:
1. A sponsor seeks 1000 patients for a clinical trial and sends clinical study criteria, including study protocol with eligibility criteria, to service provider 200.
2. Service provider 200 identifies/receives exclusion criteria (e.g. geography, e.g. availability of certified staff).
3. Service provider 200 begins a database query to obtain information regarding each of a plurality of clinical trial sites to identify potential study sites.
4. Service provider 200 modifies ranking criteria according to clinical study need.
5. Service provider 200 starts database query to get a ranked list of suitable study sites (to determine how information regarding each of the plurality of clinical trial sites relates to the obtained criteria, and to rank the sites based on the determinations).
6. Service provider 200 groups the identified sites into categories e.g. high-quality site, average quality site, low-quality site.
7. Service provider 200 eliminates low-quality sites from list.
8. Service provider 200 delivers the addresses of study sites beyond a received threshold representing 1100 patients in sum, and bills the sponsor according to the quality-level of the respective sites.

As another non-limiting example of the methodology of one embodiment of the present application, a ranking of the clinical trial sites may be done during a clinical study, as follows:
1. Study sites and sponsor agree on a quality based re-imbursement for the study site.
2. The service provider 200 develops score cards for the sites involved in the new study.
3. The service provider 200 monitors the performance quality of the different sites during the study.
4. The service provider 200 delivers the scorecards to the sponsor.
5. The sponsor reimburses the study site according to their performance.

Thus, a methodology has further been developed for examining a plurality of sites involved in clinical trial studies. Such a methodology includes obtaining criteria for clinical trial; determining, using a computer device, how each of a plurality of clinical trial sites is performing a clinical trial study, based upon the obtained criteria; and ranking the performance of the plurality of the clinical trial sites based on the determinations.

In connection with an embodiment of the present application, the service provider 200 receives/obtains in some way, the criteria for a clinical study. The service provider 200 can then compare/correlate this criteria of the clinical study protocol with electronic healthcare database clinical IT databases of one or more clinical trial sites, regarding past performance of an investigator or investigation/clinical trial site. The service provider 200 can then evaluate, utilizing the criteria and clinical data, to identify the best performing investigators or investigation/clinical trial sites. For example, the service provider 200 can review the EPR 212 to identify how many suitable patients have been treated in this particular institution (clinical trial site or investigation site) over a period of time, e.g. the past two years. A research table of the clinical workflow management system 210 may further be analyzed to determine which of the institutions or clinical trial sites include the required whole body CT scanner. Further, the EPR 212 can be used to investigate which clinical trial site is experienced in that particular procedure by counting or reviewing the number of such exams previously done in the past, for example. The service provider 200 database of patient dropout rates for this patient group may then be analyzed.

From this analysis, the service provider 200 may conclude, for example, that the study duration is reducible by six months, the overall cost is reducible by 10% and at the same time the statistical significance of 89% is achievable, as the exemplary calculated performance parameter measures for example. These performance parameter measures can be determined for a single clinical trial site or can be ranked for a plurality of clinical trial sites, wherein different performance parameter measures can be calculated for each trial site, namely different values of performance parameter measures.

From this information, the service provider 200 can then propose these improvements to the sponsor 220 of the clinical study, with a condition of a contract to the top three, for example, most suitable investigators or clinical trial or investigation sites. Plus, for particular performance parameter measures calculated, a plurality of investigation/clinical trial sites may be ranked which can achieve the calculated or satisfactory performance parameter measures. The sponsor 220 in turn can calculate the possible financial benefit if these improvements are realized.

Although a formula for calculating the risk-shared payment may depend on the actually achieved stated improvements, this risk-shared payment may be negotiated and the service provider 200 contracted on this basis. During the study, the service provider P 200 may then evaluate multiple clinical trial sites, partners, etc. by constantly re-evaluating study-relevant patient data and/or the EPR 212, for example, of enrolled patients; and by taking additional measures when actual performance is not as good as expected. Thus, the performance parameter measures can be recalculated based upon the monitored information for at least one clinical trial site, and/or a re-ranking determined. Further, a guaranteed level of performance can be provided for at least one of a plurality of clinical trial sites for the clinical trial based on the recalculated performance parameter measures and/or the re-ranking, based upon the monitored information.

The benchmarking of investigator sites according to objective criteria like sponsor-independent trial experience or profiles of patients available allows the sponsor to select reliable sites, even beyond his previous geographic scope or domain knowledge. As this will result in a saving of money and time for the sponsor, an adequate reimbursement opens a business opportunity for the service provider 200 of such a benchmarking service.

The quality-dependent compensation of investigator sites will either motivate the respective clinical trial site to increase their compliance with the study protocols or—if not—will decrease the sponsors financial obligations. In the first case, the sponsor will save time and money as the more standardized a clinical trial is performed, the faster (with a smaller patient number) the required results will be obtained. In the second case, the sponsor will save some money—especially if a clinical trial site providing invalid data can be dropped at an early stage. Both scenarios offer a service provider the opportunity to participate on the improved financial outcomes.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method of examining a plurality of sites for a clinical trial, comprising:
obtaining criteria for clinical trial;
determining, using a computer device, how information regarding each of a plurality of clinical trial sites relates to the obtained criteria; and
ranking a plurality of the clinical trial sites based on the determinations.

2. The method of claim 1, wherein the information regarding a plurality of clinical trials is stored in a memory.

3. The method of claim 1, wherein the information regarding a plurality of clinical trial sites includes a number of patients at a site.

4. The method of claim 1, wherein the information regarding a plurality of clinical trial sites includes an indication of clinical trial experience.

5. The method of claim 1, wherein the information regarding a plurality of clinical trial sites includes information concerning the obtained criteria for the clinical trial.

6. The method of claim 1, wherein the information regarding a plurality of clinical trial sites includes quality and quantity parameters.

7. The method of claim 1, wherein the comparing further includes comparing to a threshold of acceptability.

8. The method of claim 7, wherein the information regarding a plurality of clinical trial sites includes quality and performance parameters.

9. The method of claim 1, wherein the obtained criteria includes quality and performance parameters.

10. The method of claim 3, wherein the information regarding a plurality of clinical trial sites includes an indication of clinical trial experience.

11. The method of claim 10, wherein the information regarding a plurality of clinical trial sites includes information concerning the obtained criteria for the clinical trial.

12. The method of claim 11, wherein the information regarding a plurality of clinical trial sites includes quality and quantity parameters.

13. The method of claim 12, wherein the comparing further includes comparing to a threshold of acceptability.

14. The method of claim 11, wherein the information regarding a plurality of clinical trial sites includes quality and performance parameters.

15. The method of claim 11, wherein the obtained criteria includes quality and performance parameters.

16. The method of claim 1, wherein the criteria obtained includes weighting factors.

17. The method of claim 16, wherein the ranking is based upon weighted determinations.

18. The method of claim 16, wherein the weighting factors include at least one of time for performing a clinical trial, quality, and geographic location.

19. The method of claim 17, wherein the weighting factors include at least one of time for performing a clinical trial, quality, and geographic location.

20. The method of claim 1, further comprising:
monitoring at least one site during at least one clinical trial; and
re-ranking the plurality of sites based upon the monitored information.

21. The method of claim 1, further comprising:
grouping the ranked clinical trial sites into categories.

22. The method of claim 21, wherein the ranked clinical trial sites are grouped into at least two groups.

23. The method of claim 21, wherein at least one group is eliminated prior to reporting the ranking.

24. The method of claim 1, further comprising:
reporting the ranked clinical trial sites to a sponsor of the clinical trial.

25. The method of claim 24, further comprising:
receiving compensation for the reported ranking.

26. The method of claim 21, further comprising:
reporting the grouped and ranked clinical trial sites to a sponsor of the clinical trial.

27. The method of claim 26, further comprising:
receiving compensation for the reported grouping and ranking.

28. A method of examining a plurality of sites involved in clinical trial studies, comprising:
obtaining criteria for clinical trial;
determining, using a computer device, how each of a plurality of clinical trial sites is performing a clinical trial study, based upon the obtained criteria; and
ranking the performance of the plurality of the clinical trial sites based on the determinations.

29. The method of claim 28, further comprising:
grouping the ranked clinical trial sites into categories.

30. The method of claim 29, wherein the ranked clinical trial sites are grouped into at least two groups.

31. The method of claim 29, wherein at least one group is eliminated prior to reporting the ranking.

32. The method of claim 28, further comprising:
reporting the ranked clinical trial sites to a sponsor of the clinical trial.

33. The method of claim 32, further comprising:
receiving compensation for the reported ranking.

34. The method of claim 29, further comprising:
reporting the grouped and ranked clinical trial sites to a sponsor of the clinical trial.

35. The method of claim 34, further comprising:
receiving compensation for the reported grouping and ranking.

36. A method of ranking sites for a clinical trial, comprising:
obtaining criteria for clinical trial;
determining, using a computer device, how information regarding each of a plurality of clinical trial sites relates to the obtained criteria;
determining, from the determined information, which of the plurality of sites further meet a threshold of acceptability; and
ranking the sites which meet the threshold of acceptability.

37. The method of claim 36, further comprising:
grouping the ranked clinical trial sites into categories.

38. The method of claim 37, wherein the ranked clinical trial sites are grouped into at least two groups.

39. The method of claim 38, wherein at least one group is eliminated prior to reporting the ranking.

40. The method of claim 36, further comprising:
reporting the ranked clinical trial sites to a sponsor of the clinical trial.

41. The method of claim 40, further comprising:
receiving compensation for the reported ranking.

43. The method of claim 37, further comprising:
reporting the grouped and ranked clinical trial sites to a sponsor of the clinical trial.

44. The method of claim 43, further comprising:
receiving compensation for the reported grouping and ranking.

45. The method of claim 36, wherein the information regarding a plurality of clinical trials is stored in a memory.

46. The method of claim 36, wherein the information regarding a plurality of clinical trial sites includes a number of patients at a site.

47. The method of claim 36, wherein the information regarding a plurality of clinical trial sites includes an indication of clinical trial experience.

48. The method of claim 36, wherein the information regarding a plurality of clinical trial sites includes information concerning the obtained criteria for the clinical trial.

49. The method of claim 36, wherein the information regarding a plurality of clinical trial sites includes quality and quantity parameters.

50. The method of claim 36, wherein the information regarding a plurality of clinical trial sites includes quality and performance parameters.

51. The method of claim 36, wherein the obtained criteria includes quality and performance parameters.

52. The method of claim 36, wherein the criteria obtained includes weighting factors.

53. The method of claim 52, wherein the ranking is based upon weighted determinations.

54. The method of claim 52, wherein the weighting factors include at least one of time for performing a clinical trial, quality, and geographic location.

55. The method of claim 53, wherein the weighting factors include at least one of time for performing a clinical trial, quality, and geographic location.

56. The method of claim 36, further comprising:
monitoring at least one site during at least one clinical trial; and
re-ranking the plurality of sites based upon the monitored information.

57. A method of providing sites for a clinical trial, comprising:
determining, using a computer device, a relationship between information regarding each of a plurality of clinical trial sites relates and criteria for a desired clinical trial; and
providing a level of guarantee of performance for at least one of the plurality of the clinical trial sites, for the desired clinical trial, based on the determinations.

58. The method of claim 57, further comprising:
reporting the determined information to a sponsor of the clinical trial.

59. The method of claim 58, further comprising:
receiving compensation for the reported information.

60. The method of claim 57, wherein a plurality of varying levels of guarantee are provided for a plurality of the clinical trial sites.

61. The method of claim 57, wherein the criteria includes weighting factors.

62. The method of claim 61, wherein the level of guarantee is based upon weighted determinations.

63. The method of claim 61, wherein the weighting factors include at least one of time for performing a clinical trial, quality, and geographic location.

64. The method of claim 62, wherein the weighting factors include at least one of time for performing a clinical trial, quality, and geographic location.

65. The method of claim 60, further comprising:
monitoring at least one site during at least one clinical trial; and
providing revised levels of guarantee for the plurality of sites based upon the monitored information.

66. The method of claim 60, wherein the criteria includes weighting factors.

67. The method of claim 66, wherein the levels of guarantee are based upon weighted determinations.

68. The method of claim 66, wherein the weighting factors include at least one of time for performing a clinical trial, quality, and geographic location.

69. The method of claim 67, wherein the weighting factors include at least one of time for performing a clinical trial, quality, and geographic location.

70. A device for implementing the method of claim 1.

71. A device for implementing the method of claim 28.

72. A device for implementing the method of claim 36.

73. A device for implementing the method of claim 57.

74. A program, adapted to perform the method of claim 1, when executed on a computer device.

75. A computer readable medium, storing the program of claim 74.

76. A program, adapted to perform the method of claim 28, when executed on a computer device.

77. A computer readable medium, storing the program of claim 76.

78. A program, adapted to perform the method of claim 36, when executed on a computer device.

79. A computer readable medium, storing the program of claim 78.

80. A program, adapted to perform the method of claim 57, when executed on a computer device.

81. A computer readable medium, storing the program of claim 80.

82. A method of ranking a plurality of clinical trial sites for potential performance of a clinical trial, comprising:
creating a first electronic database of criteria for the clinical trial;
creating a second electronic database of rules for calculating performance measures from the criteria and clinical data;
evaluating the first and second databases and the clinical data to calculate the performance measures for a plurality of clinical trial sites;
storing the performance measures in a third database; and
deriving, from the third database, a ranking of the performance measures for ranking the clinical trial sites for potential performance of the clinical study.

83. The method of claim 82, further comprising:
grouping the ranked clinical trial sites into categories.

84. The method of claim 83, wherein the ranked clinical trial sites are grouped into at least two groups.

85. The method of claim 84, wherein at least one group is eliminated prior to reporting the ranking.

86. The method of claim 82, further comprising:
reporting the ranked clinical trial sites to a sponsor of the clinical trial.

87. The method of claim 86, further comprising:
receiving compensation for the reported ranking.

88. The method of claim 83, further comprising:
reporting the grouped and ranked clinical trial sites to a sponsor of the clinical trial.

89. The method of claim 88, further comprising:
receiving compensation for the reported grouping and ranking.

90. The method of claim 82, wherein the criteria for the clinical study includes at least one performance parameter

91. The method of claim 90, wherein performance parameter measures are derived for at least one performance parameter.

92. An apparatus for ranking a plurality of clinical trial sites for potential performance of a clinical trial, comprising:
a first electronic database including criteria for the clinical study;
a second electronic database including rules for calculating performance measures from the criteria and from clinical data;
a rules engine, adapted to interface with and evaluate the first and second databases and the clinical data to calculate the performance measures; and
a third database for storing the calculated performance measures, wherein a ranking of the performance measures is derivable from the third database for use in improving the clinical study.

93. The apparatus of claim 92, wherein the ranked clinical trial sites are further groupable into categories.

94. The apparatus of claim 93, wherein the ranked clinical trial sites are groupable into at least two groups.

95. The apparatus of claim 94, wherein at least one group is eliminated prior to reporting the ranking.

96. The apparatus of claim 92, wherein the ranked clinical trial sites are then reportable to a sponsor of the clinical trial.

97. The apparatus of claim 96, wherein compensation for the reported ranking is receivable.

98. The apparatus of claim 93, wherein the ranked clinical trial sites are then reportable to a sponsor of the clinical trial.

99. The apparatus of claim 98, wherein compensation for the reported ranking is receivable.

100. An apparatus for examining a plurality of sites for a clinical trial, comprising:
means for obtaining criteria for clinical trial; and
means for determining how information regarding each of a plurality of clinical trial sites relates to the obtained criteria, and for ranking a plurality of the clinical trial sites based on the determinations.

101. The apparatus of claim 100, wherein the ranked clinical trial sites are further groupable into categories.

102. The apparatus of claim 101, wherein the ranked clinical trial sites are groupable into at least two groups.

103. The apparatus of claim 102, wherein at least one group is eliminated prior to reporting the ranking.

104. The apparatus of claim 100, wherein the ranked clinical trial sites are then reportable to a sponsor of the clinical trial.

105. The apparatus of claim 104, wherein compensation for the reported ranking is receivable.

106. The apparatus of claim 101, wherein the ranked clinical trial sites are then reportable to a sponsor of the clinical trial.

107. The apparatus of claim 106, wherein compensation for the reported ranking is receivable.

108. An apparatus for examining a plurality of sites involved in clinical trial studies, comprising:
means for obtaining criteria for clinical trial; and
means for determining how each of a plurality of clinical trial sites is performing a clinical trial study, based upon the obtained criteria, and for ranking the performance of the plurality of the clinical trial sites based on the determinations.

109. The apparatus of claim 108, wherein the ranked clinical trial sites are further groupable into categories.

110. The apparatus of claim 109, wherein the ranked clinical trial sites are groupable into at least two groups.

111. The apparatus of claim 110, wherein at least one group is eliminated prior to reporting the ranking.

112. The apparatus of claim 108, wherein the ranked clinical trial sites are then reportable to a sponsor of the clinical trial.

113. The apparatus of claim 112, wherein compensation for the reported ranking is receivable.

114. The apparatus of claim 109, wherein the ranked clinical trial sites are then reportable to a sponsor of the clinical trial.

115. The apparatus of claim 114, wherein compensation for the reported ranking is receivable.

116. An apparatus for ranking sites for a clinical trial, comprising:
means for obtaining criteria for clinical trial; and
means for determining how information regarding each of a plurality of clinical trial sites relates to the obtained criteria, for determining, from the determined information, which of the plurality of sites further meet a threshold of acceptability, and for ranking the sites which meet the threshold of acceptability.

117. The apparatus of claim 116, wherein the ranked clinical trial sites are further groupable into categories.

118. The apparatus of claim 117, wherein the ranked clinical trial sites are groupable into at least two groups.

119. The apparatus of claim 118, wherein at least one group is eliminated prior to reporting the ranking.

120. The apparatus of claim 116, wherein the ranked clinical trial sites are then reportable to a sponsor of the clinical trial.

121. The apparatus of claim 120, wherein compensation for the reported ranking is receivable.

122. The apparatus of claim 117, wherein the ranked clinical trial sites are then reportable to a sponsor of the clinical trial.

123. The apparatus of claim 122, wherein compensation for the reported ranking is receivable.

124. An apparatus for providing sites for a clinical trial, comprising:
means for determining a relationship between information regarding each of a plurality of clinical trial sites relates and criteria for a desired clinical trial; and
means for providing a level of guarantee of performance for at least one of the plurality of the clinical trial sites, for the desired clinical trial, based on the determinations.

125. The apparatus of claim 124, wherein the ranked clinical trial sites are further groupable into categories.

126. The apparatus of claim 125, wherein the ranked clinical trial sites are groupable into at least two groups.

127. The apparatus of claim 126, wherein at least one group is eliminated prior to reporting the ranking.

128. The apparatus of claim 124, wherein the ranked clinical trial sites are then reportable to a sponsor of the clinical trial.

129. The apparatus of claim 128, wherein compensation for the reported ranking is receivable.

130. The apparatus of claim 125, wherein the ranked clinical trial sites are then reportable to a sponsor of the clinical trial.

131. The apparatus of claim 130, wherein compensation for the reported ranking is receivable.

132. An apparatus for ranking a plurality of clinical trial sites for potential performance of a clinical trial, comprising:
means for creating a first electronic database of criteria for the clinical trial and for creating a second electronic database of rules for calculating performance measures from the criteria and clinical data;
means for evaluating the first and second databases and the clinical data to calculate the performance measures for a plurality of clinical trial sites;
means for storing the performance measures in a third database; and
means for deriving, from the third database, a ranking of the performance measures for ranking the clinical trial sites for potential performance of the clinical study.

133. The apparatus of claim 132, wherein the ranked clinical trial sites are further groupable into categories.

134. The apparatus of claim 133, wherein the ranked clinical trial sites are groupable into at least two groups.

135. The apparatus of claim 134, wherein at least one group is eliminated prior to reporting the ranking.

136. The apparatus of claim 132, wherein the ranked clinical trial sites are then reportable to a sponsor of the clinical trial.

137. The apparatus of claim 136, wherein compensation for the reported ranking is receivable.

138. The apparatus of claim 133, wherein the ranked clinical trial sites are then reportable to a sponsor of the clinical trial.

139. The apparatus of claim 138, wherein compensation for the reported ranking is receivable.
